(19) United States
(12) Patent Application Publication
(10) Pub. No.: US 2006/0026265 A1
(43) Pub. Date: Feb. 2, 2006

(54) Digital media downloading system

(76) Inventors: Paul Grady Russell, Campbell, CA (US); Timothy James Lalley, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/910,031

(22) Filed: Aug. 2, 2004

(51) Int. Cl. G06F 15/16

(52) U.S. Cl. 709/219

(57) ABSTRACT

This invention discloses a device and methods for downloading digital media utilizing of a kiosk or plurality of kiosks coupled to a remote server. The kiosk and server cooperatively provide access for users to purchase digital media. In a preferred embodiment, all or part of the digital media is stored at the kiosk(s) for immediate transfer to a copying means. This system allows the user to interact with the system without having to wait for long digital media transfer rates between the remote server and the kiosk(s).

### BACKGROUND OF THE INVENTION

1. Field of the Invention

The present invention relates generally to a public digital media downloading system. More particularly, the present invention relates to a kiosk or plurality of kiosks that contain at least part of a digital media library on storage for faster downloading. The kiosk(s) are connected to a remote server for updates of the digital media and to keep track of transaction information.

2. Related Art

With the current advances in technology the market has seen a wide array of kiosk-like terminals for various purposes. Public Internet terminals common in the market today allow a user to pay a specified fee for Internet access. The user can access the Internet from the terminal, or in some cases the terminal has a wireless LAN router to allow a user to have his/her own laptop computer online. Users generally pay per minute for access and are usually allowed to download, print, or email information.

From this technology various downloading systems have been conceived. These systems act as “vending machines” for digital media such as music, books, etc. Current downloading systems generally consist of a kiosk that has a payment means, a slot for a memory card or a data port for connection to the user's laptop computer. They also consist of a remotely connected server. The server processes user requests and downloads the desired media to the memory card located in the kiosk via an internet-type connection. This process is undesirable because it is limited by the bandwidth between the server and the kiosk. Broadband connections have helped in part, but even at peak performance media file transfer rates are still much slower than a disk-to-disk transfer. Other factors can further limit broadband connections such as multiple users accessing the same files at the same time. Furthermore, connection bandwidth limitations make it impractical to download video and other types of media that may have large file sizes.

### SUMMARY OF THE INVENTION

It is recognized that it would be advantageous to develop a downloading system that can utilize the speed of a disk-to-disk transfer.

The invention provides a digital media downloading system. This device consists of a kiosk or plurality of kiosks coupled to a remote server. The kiosk(s) comprise of a computer, a user interface coupled to the computer, and a memory device slot coupled to the computer. The kiosk and server cooperatively contain circuitry and software to provide access for users to purchase digital media wherein all or part of the digital media is stored at the kiosk(s) for immediate transfer to a memory device. This system allows the user to interact with the system without having to wait for long digital media transfer rates between the remote server and the kiosk(s).

The present invention may also be embodied as a method for downloading digital media. This method includes the steps of (a) providing a kiosk or plurality of kiosks comprised of a computer, a user interface, and a memory device slot, (b) linking the kiosk(s) with a remote server having a database of a digital media library, (c) placing at least part of the digital media library on storage within the kiosk(s) for immediate transfer to a local user, (d) downloading by a user of at least part of the digital media library onto a memory device, (e) communicating transaction data relating to the downloading between the kiosk(s) and the remote server, and (f) updating the kiosk(s) with new digital media from the remote server.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a block diagram of a digital media downloading device in accordance with an embodiment of the present invention;

FIG. 2 illustrates the a possible implementation of FIG. 1 on a micro scale;

FIG. 3 is a flow chart in accordance with a possible method embodiment of the present invention; and

FIG. 4 is a flow chart in accordance with another possible method embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

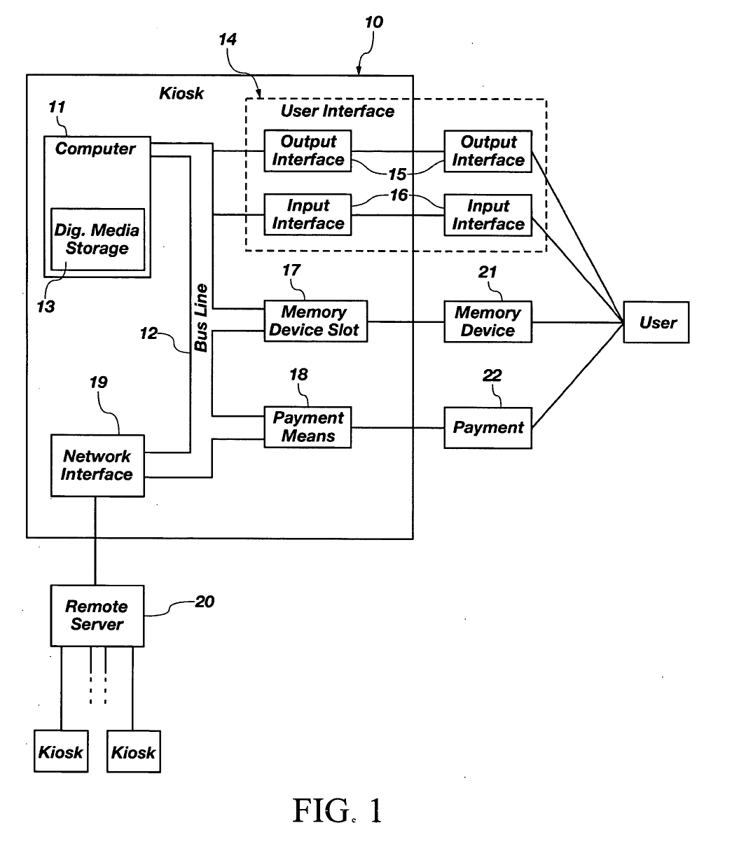

FIG. 1 illustrates an embodiment of the present invention wherein a kiosk, indicated generally at 10, comprises a computer 11 that is electronically coupled with an intervening bus line 12 to a user interface 14, a memory device slot 17, and a remote server 20 via a network interface 19. The computer 11 along with the remote server 20 cooperatively contains circuitry and software to provide access for users to download digital media onto a memory device. It should be noted that digital media could refer to anything able to be stored on a computer including music files, audio/video files, books, and software. The computer includes a digital media storage space 13 to store at least part of a digital media library. This storage allows the user to have a disk-to-disk type transfer within the system, and without delays associated with transfer rates between the remote server 20 and the kiosk 10.

The user interface 14 may include an output interface 15 and an input interface 16. The output interface 15 may include video output means to a monitor for the user to read while operating the kiosk. It may also include an audio output means to speakers or earphones so the user may preview possible audio digital media files. The input interface 16 may include a keyboard or mouse for the user to control operations of the kiosk. These interfaces may be combined, as would be the case for a touch screen system, which both displays output information and accepts user input. Various output interface 15 and input interface 16 means are well known in the field and one with skill in the art could implement them in many ways.

The memory device slot 17 is configured to accept a memory device 21 from a user. This device slot may have a special proprietary design or be configured to one of the standard memory devices used currently in the market such as ROM/RAM devices, hard/floppy disks, flash memory, and any other removable memory device. An example of a removable memory device could include an actual electronic device such as an MP3 player or a PDA. Many times the internal memory on these devices act like common USB flash memory devices, which could be a feature exploited for the present invention.

A network interface 19 to connect to the remote server 20 is preferably done via an Internet connection. This could be implemented through a satellite, cable, or phone connection. In some cases the remote server may be in reasonable proximity to the kiosk. In this case any other network connection means including LAN, IEEE 1394, wireless LAN, and USB could be used.

In accordance with one aspect of the present invention, the kiosk 10 may provide a payment means 18 wherein the user may insert a payment 22. This payment may be by any method suitable for the present invention including cash, credit card, ATM card, phone card, etc.

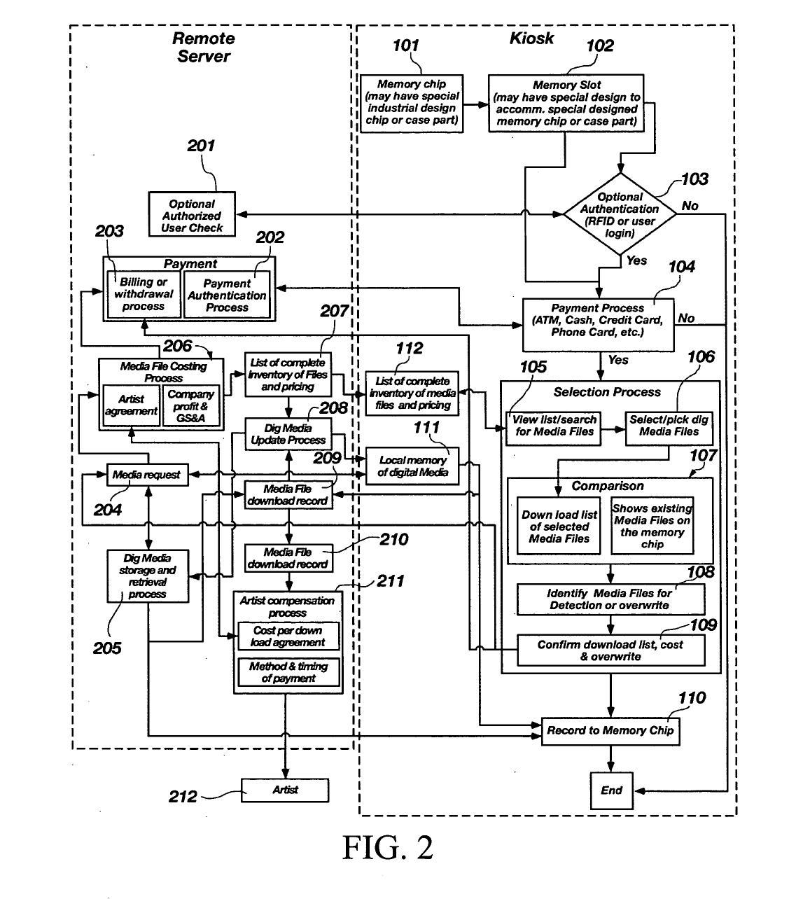

FIG. 2 illustrates by way of example the workings of the present invention on a slightly more micro scale than FIG. 1. The explanation of this figure is broken into three different processes that occur within the downloading system namely, a user session process, a system update process, and an artist compensation process. These processes may be done in parallel or in any convenient time frame to allow maximum performance of the system for the user. It should be noted that the terms digital media and media are used interchangeably throughout the drawing and explanation. It is also noted that any data that is relayed in the system that is not actual digital media being transferred is considered transaction data such as payment/user authentications, download records, and artist royalty information. Also any given block may represent circuitry and software to implement its outlined functions.

A typical user session could start by a user placing their memory device 101 into a memory device slot 102. At this point the system asks for a user login 103 which would be authenticated by the remote server 201. This login is optional and is designed for the case that a user has a subscription to this downloading service. Having subscriptions could set a variety of payment options such as a flat monthly fee for a specified number of downloads, billing per use, etc. Following the optional login the system goes to a payment process 104. The payment can be taken by any means including cash, credit card, ATM card, phone card, and account billing. In most cases some sort of payment authentication will be needed 202.

The user goes to a media selection process wherein he may either view a list of media files or search for specific files 105. Media lists may be categorized by file types, sizes, genres, etc. The user would go through the available inventory of media and select files for downloading 106. To assure that the selected media will fit on the memory device a comparison between selected media and existing media on the memory device could be used 107. If applicable the user could identify media files to be removed 108 from memory to increase free space on the memory device, or the user could remove media selected from the inventory lists. At the end of the selection process the user would confirm the download list, download cost, and files to overwrite 109. At this point a confirmation payment is needed that will cause the system to communicate with the remote server at 203. Upon positive confirmation, a media request is sent to 204. This request is handled within the remote server, but it could also be handled within the kiosk.

With the selection process done the system then records the digital media onto the memory device 110. The media request block 204 communicates with both the local memory of digital media 111 on the kiosk and the digital media storage 205 within the remote server. If the media is located within the local memory 111, it is recorded to the memory device from that block. Otherwise it is sent from the digital media storage 205 within the server. Downloading the media from the local memory creates an advantage due to the fast transfer rate of disk-to-disk transfers. When the recording is complete the user may remove the memory device personal use of the downloaded digital media.

A system update process would be used when digital media is introduced, deleted, or moved within the system. An update would also be needed when changes are made regarding pricing of the media. When media is introduced or removed it will first go into a media file costing process 206. The costing process 206 will use information regarding contracts with artists and other companies. That information along with other factors will determine the price of the media. Next the media will be added or removed from the list of inventory and pricing within the server and the kiosk 112, 207. The list of complete inventory within the kiosk 112 will also update part of the selection process 105 for the user session.

When the inventory is changed in the system it will go through a digital media update process 208. The update process 208 will place the new media or remove the old media to either the local memory 111 or the server storage 205. The placement of digital media will be such that the user session is optimized. For example, it may be best to place the most popular downloads to the local memory 111, or it may be best to select media with larger file sizes on the local memory 111 to reduce transfer time. A media file download record 209 may keep statistics that will help in these decisions. Many different techniques could be implemented while deciding where to store the digital media. Each will have to take into account factors such as length of transfer time, limited storage space on the kiosk, etc. System updates may be done at any time, but preferably during off peak hours to limit any inconveniences that may occur during a user download session.

The artist compensation process could begin with the media files download record 209, which keeps track of any file transmitted from storage 111, 205. A reporting process 210 takes the download record into an artist compensation process 211. This compensation process examines the artist agreement 206 and conforms payments per the agreement. The compensation process would determine the method and timing of payments to the artist or company and then the payment will be conveyed 212.

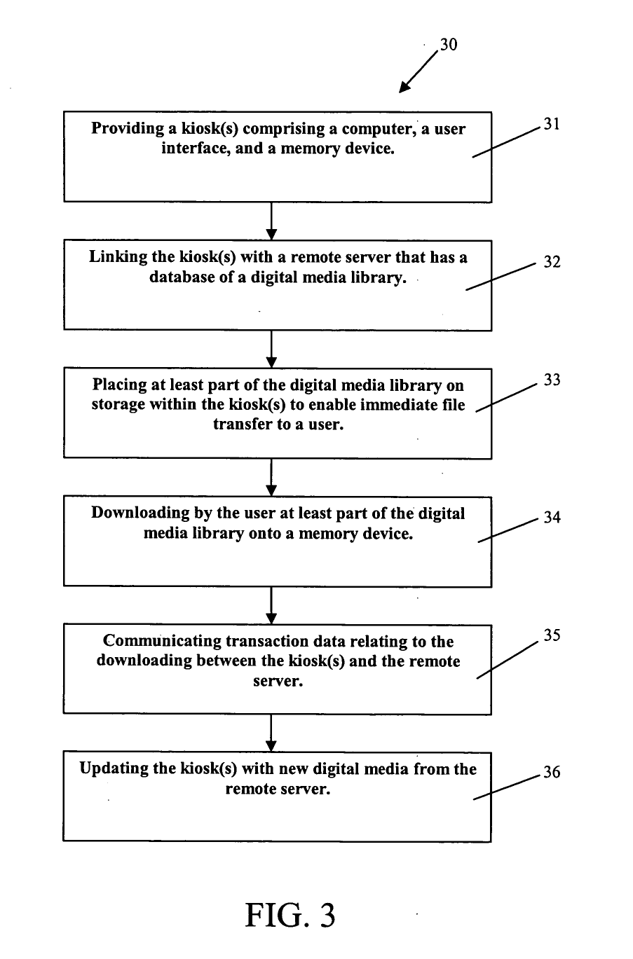

FIG. 3 illustrates a possible flow chart for a method to download digital media 30 in accordance to one embodiment of the present invention. This method comprises the steps of,
(i) providing a kiosk(s) comprised of a computer, a user interface, and a memory device slot 31, (ii) linking the kiosk(s) with a remote server having a database of a digital media library 32, (iii) placing at least part of the digital media library on storage within the kiosk(s) for immediate transfer to a local user 33, (iv) downloading by the user of at least part of the digital media library onto a memory device 34, (v) communicating transaction data relating to the downloading between the kiosk(s) and the remote server 35, and (vi) updating the kiosk(s) with new digital media from the remote server 36.

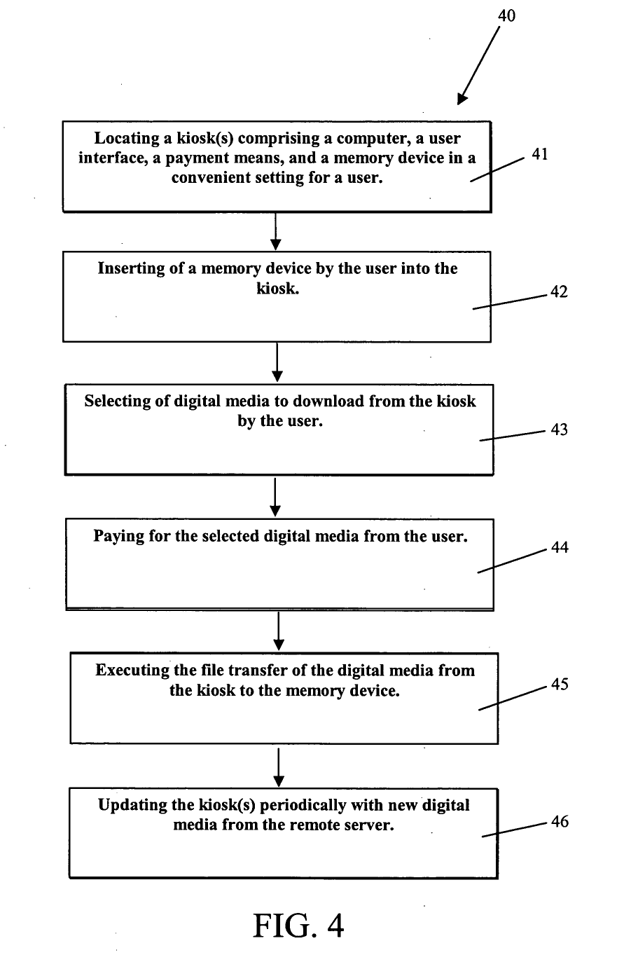

FIG. 4 illustrates another possible flow chart for a method to download digital media 40 in accordance to one embodiment of the present invention. This method comprises the steps of (i) locating a kiosk comprising a computer, a user interface, a payment means, and a memory device slot in a convenient setting for a user 41, (ii) inserting a memory device by the user into the kiosk 42, (iii) selecting digital media to be downloaded from the kiosk 43, (iv) paying for the selected digital media 44, (v) executing the file transfer from the kiosk to the memory device 45, (vi) communicating transaction data between the kiosk and a remote server 46, and (vii) updating the kiosk periodically with new digital media from the remote server 47.

It is to be understood that the above-referenced arrangements are illustrative of the application for the principles of the present invention. It will be apparent to those of ordinary skill in the art that numerous modifications can be made without departing from the principles and concepts of the invention as set forth in the claims.

What is claimed is:

1. A digital media downloading system comprising,
a) at least one kiosk having,
a computer;
a user interface coupled to the computer; and
a memory device slot coupled to the computer; and
b) at least one remote server wherein said kiosk is configured for coupling to the remote server which cooperatively contains circuitry and software to provide access for users to download digital media;
c) wherein at least part of the digital media is stored at the kiosk for immediate transfer to a memory device, thereby allowing the user to interact with the system without delays associated with long digital media transfer rates between the remote server and the kiosk.

2. The device in claim 1, wherein the at least one kiosk includes circuitry and software for communicating with the remote server to receive updates with new digital media on a recurring, periodic basis.

3. The device in claim 1 wherein the at least one kiosk and the remote server include circuitry and software that authenticates a user logging into an account.

4. The device in claim 1 wherein the remote server includes circuitry and software that keeps an accounting of the kiosk(s) transaction data.

5. The device in claim 4, wherein the transaction data includes data regarding royalties.

6. The device in claim 4, wherein the transaction data includes data regarding user accounts.

7. The device in claim 4, wherein the transaction data includes statistics regarding the digital media being downloaded.

8. The device in claim 1, wherein the memory device is selected from the group consisting of ROM/RAM devices, hard/floppy disks, flash memory, and removable memory devices.

9. The device in claim 1, wherein the kiosk(s) contains a payment means for receiving payment.

10. The device in claim 9, wherein the payment means includes a cash input slot.

11. The device in claim 9, wherein the payment means includes a credit card reader.

12. The device in claim 9, wherein the kiosk(s) and the remote server include circuitry and software that authenticates the payment made by the user.

13. The device in claim 1, further comprising a remote server including circuitry and software configured to bill a user account.

14. The device in claim 5, wherein the remote server includes software to pay royalties to an artist who may have copyright privileges on a particular piece of digital media.

15. The device in claim 1, wherein the digital media is selected from the group consisting of music, audio/video, software, and books.

16. A method for downloading digital media, comprising:
a) providing a kiosk(s) including a computer, a user interface, and a memory device slot;
b) linking the kiosk(s) with a remote server having a database of a digital media library;
c) placing at least part of the digital media library on storage within the kiosk(s) for immediate transfer to a local user;
d) downloading by the user of at least part of the digital media library onto a memory device;
e) communicating transaction data relating to the downloading between the kiosk(s) and the remote server; and
f) updating the kiosk(s) with new digital media from the remote server.

17. The method of claim 16, further comprising the step of authenticating a user logging into an account.

18. The method of claim 16, further comprising the step of accounting of the kiosk(s) transaction data by the remote server.

19. The method of claim 18, wherein the transaction data includes data regarding royalties.

20. The method of claim 18, wherein the transaction data includes data regarding user accounts.

21. The method of claim 18, wherein the transaction data includes statistics regarding the digital media being downloaded.

22. The method of claim 16, wherein the memory device is selected from the group consisting of ROM/RAM devices, hard/floppy disks, flash memory, and removable memory devices.

23. The method of claim 16, further comprising the step of purchasing the digital media to be downloaded by the user.

24. The method of claim 23, further comprising the step of billing a user account by the remote server.

25. The method of claim 19, further comprising the step of paying royalties to an artist who may have copyright privileges on a particular piece of digital media by the remote server.

26. A method for downloading digital media, comprising,
a) locating a kiosk comprising a computer, a user interface, a payment means, and a memory device slot in a convenient setting for a user;
b) inserting a memory device by the user into the kiosk;
c) selecting digital media to be downloaded from the kiosk;
d) paying for the selected digital media;
e) executing the file transfer from the kiosk to the memory device;
f) communicating transaction data between the kiosk and a remote server; and
g) updating the kiosk periodically with new digital media from the remote server.

27. The method of claim 26, further comprising the step of authenticating a user logging into an account.

28. The method of claim 261, further comprising the step of accounting of the kiosk transaction data by the remote server.

29. The method of claim 28, wherein the transaction data includes data regarding royalties.

30. The method of claim 28, wherein the transaction data includes data regarding user accounts.

31. The method of claim 26, wherein the remote server is connected to a plurality of kiosks.

32. The method of claim 26, further comprising the step of billing a user account by the remote server.

33. The method of claim 29, further comprising the step of paying royalties to an artist who may have copyright privileges on a particular piece of digital media by the remote server.
